(19) United States
(12) Patent Application Publication
(10) Pub. No.: US 2007/0069517 A1
(43) Pub. Date: Mar. 29, 2007

(54) Threaded pipe and pipe joint and method of use

(76) Inventors: Shigeo Nagasaku, Nishinomiya-shi (JP); Jean Francois Charvet-Quemin, Valenciennes (FR); Jean Pierre Emery, Maubeuge (FR)

Correspondence Address: CLARK & BRODY, 1090 VERMONT AVENUE, NW, SUITE 250, WASHINGTON, DC, 20005, US

(21) Appl. No.: 11/486,036

(22) Filed: Jul. 14, 2006

Related U.S. Application Data
(60) Provisional application No. 60/701,519, filed on Jul. 22, 2005.

(51) Int. Cl. F16L 25/00

(52) U.S. Cl. 285/333

(57) ABSTRACT

A threaded pipe joint has a reduced overall diameter at the joint by controlling the thickness of both the box end and pin end. Each of the box and pin ends have defined cross sectional wall thicknesses Sc and Sp1, respectively. Each of Sc and Sp1 are sized as a fraction of the overall pipe cross sectional thickness Sp, the fraction ranging between (0.55-0.79). The box and pin ends can vary in taper from 1/12 to 1/20.

### TECHNICAL FIELD

The present invention relates to a threaded pipe coupling, and in particular to a threaded connection having special thickness relationships between the threaded portion of a pin portion of the pipe, and a threaded portion of a box portion of a coupling.

### BACKGROUND ART

In the prior art, various designs of threaded pipe joints have been proposed for producing strings or lines of pipes for the oil industry. One goal of the oil industry is to reduce the diameter of the down hole of an oil well. Normally, oil well pipes having threaded joints on both ends, and the pipes are connected together through female couplings linking with the opposing males ends of adjacent pipes. The outer diameter of the female coupling is the largest so it is this diameter that controls the diameter of the down hole.

Various techniques and designs have been proposed to minimize the down hole diameter. One example of such a proposal is taught in U.S. Pat. No. 5,687,999 to Lancry et al., herein incorporated by reference. This patent describes a threaded joint for tubes, wherein each of the male and female element of a coupling have two shifted frustoconical threaded sections with vanishing threads at the two ends as a result of convergences of frustoconical envelop surfaces and cylindrical surfaces. The joint also has a central abutment that cooperates with negative flank threads to reinforce the male/female connection and two internal and external ring-shaped metal/metal tightness zones that prevent the penetration of fluid into the threaded zones.

One drawback of the design of the joint disclosed in the Lancry et al. patent is that it is necessary to swage or expand the edge of the pipes to extend the diameter of the edge, see col. 9, lines 60 to col. 10, line 18. While this swaging is not as much of a problem when using low alloy steels as the material for the pipe, swaging becomes much more difficult when employing a highly alloyed material such as steel containing 13% chromium, because the swaging may compromise the corrosion resistance of the pipe.

Therefore, a need exists to provide improved pipe joint designs that reduce the diameter of the coupling without compromising other properties or characteristics of the joint that are important to drilling.

### SUMMARY OF THE INVENTION

One object of the present invention is an improved threaded pipe joint.

Another object of the present invention is a threaded pipe joint that includes a male end section and a female end section that are especially configured to minimize the diameter of the female end section, thus allowing for the durability of the threaded pipe joint to external pressure without a loss in sealing performance and anti-galling characteristics.

Other objects and advantages of the invention will become apparent for the following description.

### BRIEF DESCRIPTION OF THE DRAWINGS

preferred embodiment of the invention is illustrated in the accompanying representations in which:

FIG. 1 is a schematic view of a prior art threaded pipe joint;

FIG. 2 is a schematic view of a portion of a thread pipe joint according to a first embodiment of the invention.

FIG. 3 is a schematic view of a portion of a thread pipe joint according to a first embodiment of the invention.

FIGS. 4a-e show a joint of FIG. 2 in separated form, with detail as to the thread configurations.

### DETAILED DESCRIPTION OF THE PREFERRED EMBODIMENTS

The present invention is an improvement in threaded pipe joints, and particularly, threaded pipe joints that are designed to minimize the outer diameter of the female coupling so as to minimize the diameter of a down hole for oil drilling.

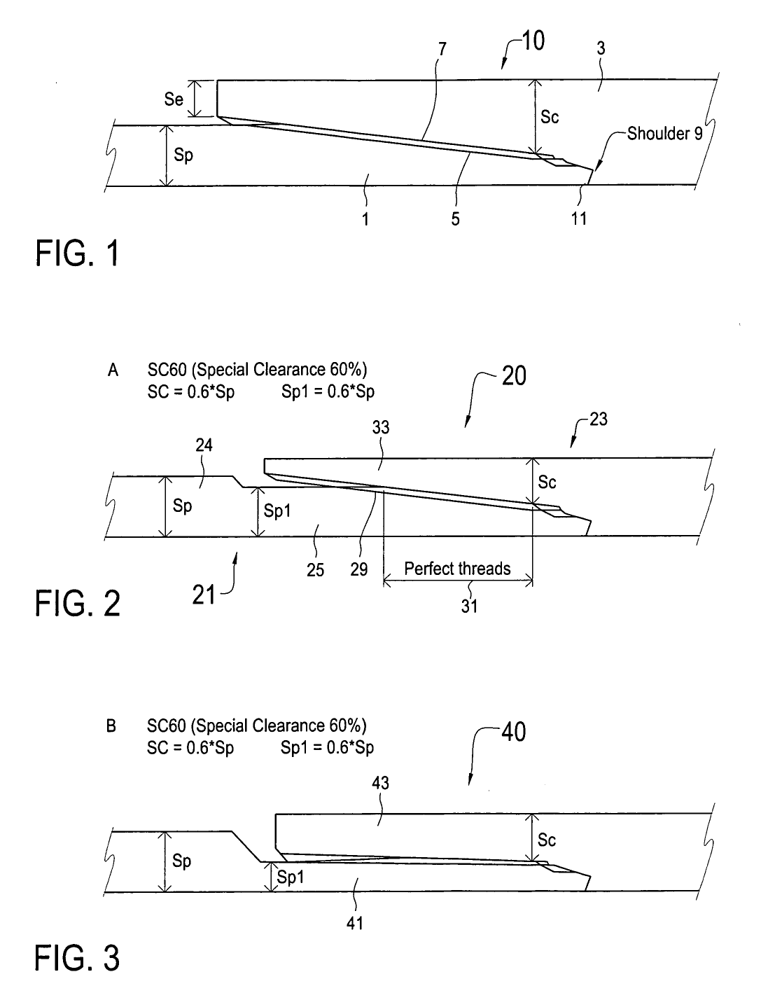

Referring now to FIG. 1, a typical prior art pipe joint is designated by the reference numeral 10 and is seen to include a male pin 1 or male end portion, and a female box 3 or female end portion. The male pin 1 has a threaded tapered portion 5 and is shown with a pipe cross sectional thickness of Sp. The female box 3 has a cross sectional thickness Sc with threads 7, with Sc measured at the onset of perfect threads. The edge of the box is defined by a sectional thickness Se.

For couplings or boxes, the critical section for bearing the tensile force is at the inner end region of the thread (at Sc), because at this region, only the coupling bears the force and the cross section of the coupling becomes smallest.

It is normal in the prior art for the cross section of the pipe (Sp) to be same as the cross section of the critical section (Sc). This is so because reducing the outer diameter of the coupling, i.e., making Sc less, results in reducing the bearing tensile force. But for compression force, the shoulder 9 located at the tip 11 of the pin also bears the force, so the coupling with less Sc can still bear compression force adequately. Near the bottom of down holes, the tensile force to the coupling is not so large because the number of connected pipes below it is small. On the other hand, compression force may be still high at the bottom because such force originates from the circumstance of the pipes. Since the tensile forces are not so high near the bottom of the down holes, it is not necessary that Sc match Sp, as would be the case where tensile forces are high.

Thus, a coupling can be made wherein Sc is 80% of Sp, or Sc=0.80 Sp. This can be accomplished by merely making the box 3 with a smaller outside diameter. However, reducing the diameter more, e.g., Sc=0.60 Sp, causes the thickness Se to be very small, and this reduced thickness region does not bear the hoop stress by the internal pressure and interference of threads. A solution to this problem would be to control the interference of the threads 5 and 7, but doing so requires severe control of the thread dimensions, and such is not cost effective or practical.

The invention proposes an alternative approach to obtain a joint with a reduced diameter of the box, e.g., the thickness of the box Sc equals 0.60 Sp. This is accomplished by reducing the diameter of the tapered male end or pin of the pipe. This is illustrated in FIG. 2, wherein a joint according to the invention is designated as 20 and includes a pin 21 and a box 23. The pin 21 extends from the pipe, which has a normal thickness Sp. A tapering diameter portion 25 of the pin 21 contains threads 29, with the perfect thread length identified as 31 (the threads are perfect at full height and considered imperfect by having incomplete or partial height, for example run-out or run-in threads). The constant diameter portion thickness is designated as Sp1 which is measured where the tapered end steps down from the main pipe portion 24. The box 23 has a female tapered end portion 33 with its thickness identified as Sc in the region of reduced thickness, measured where the tapered threads at the inner region of the box begin. By reducing the diameter Sp1 of pin 21, the thickness Sc of the coupling or box is ensured. In the FIG. 2 embodiment, the taper is 1/12.

A preferred relationship between Sc (special clearance) and Sp, and Sp1 and Sp are shown in FIG. 2. That is, Sc=0.6 Sp, and Sp1=0.6 Sp. A preferred range of the multiplier to relate Sc and Sp and Sp1 and Sp is between 0.54 and 0.79, with a more preferred range being between 0.58 and 0.65. In another preference and to ensure the bearing of tensile force, Sp1 should not be less than Sc.

FIG. 3 shows another embodiment of the invention as reference numeral 40, which has a pin 41 and box 43. This embodiment differs from the one shown in FIG. 2 in that the taper of the threaded male end of the pin 41 is 1/20 as compared to the FIG. 2 taper of 1/12. This results in a longer threaded length as compared to the joint 20 of FIG. 2. It should be understood that the taper can vary for the inventive joint, with examples of tapers ranging from 1/12 to 1/16 to 1/18, and 1/20. Because of the different tapers, the perfect thread length and imperfect thread length for steeper tapered joints such as the joint 20 shown in FIG. 2 is shorter than it is for the slower tapered joints such as joint 40 shown in FIG. 3. While it is desirable to have the maximum taper, the particular application of the pipe joint may dictate slower tapers. For example, variables such as the desired outside diameter and thickness, desired perfect thread length, and acceptable connection stress will contribute to the determination of the desired taper. Since this determination is well known in the art, a further description is not deemed necessary for understanding of the invention.

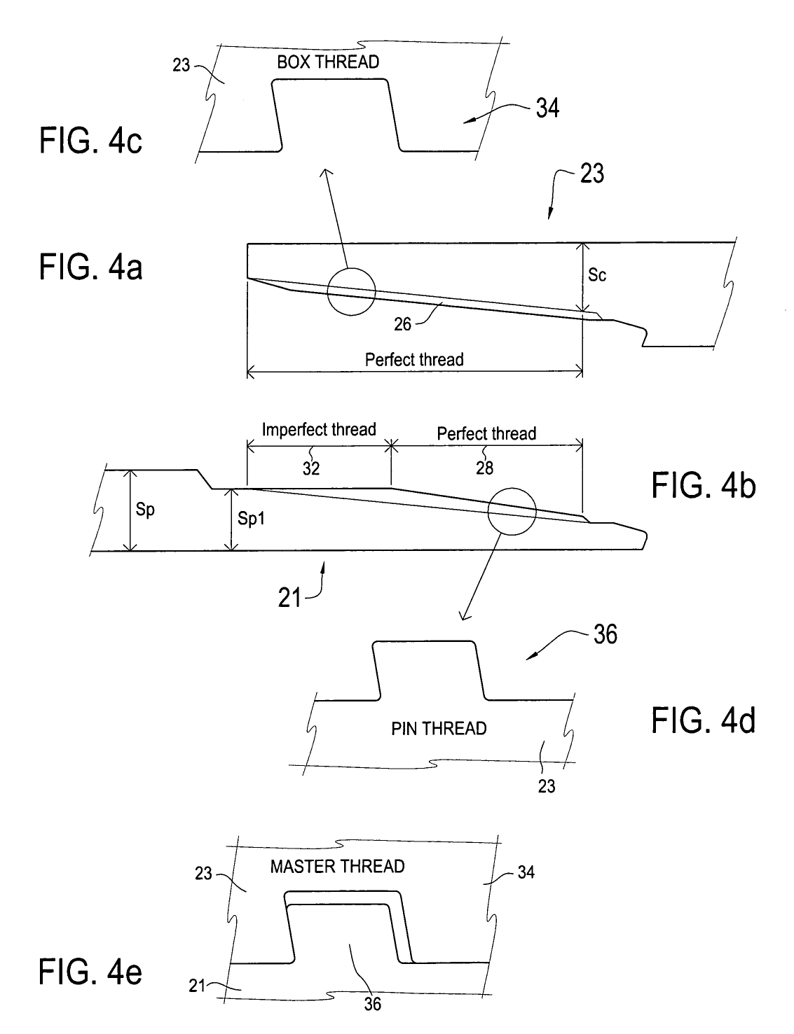

FIGS. 4a-e show in more detail how the pin 21 and box 23 interface. The box 23 is shown with threaded portion 26 in FIG. 4a, with the pin having a combination of perfect threads 28 and imperfect threaded 32. FIG. 4c shows an enlarged thread configuration 34 for the box 23 with FIG. 4d showing an enlarged thread configuration 36 for the pin. FIG. 4e shows the mating as numeral 38 of the threads of the box and pin.

Referring to FIGS. 2 and 3, because the outer diameter of the thread of the pin is reduced, there is not enough thickness to make the usual tapered threads on the pin. In the threads of FIG. 2, the length of perfect threads is shortened. The remaining part is imperfect threads, which do not bear the force substantially. In the threads of FIG. 3, the tapered angle is slower than FIG. 2, thus allowing for a longer perfect thread length. In order to have a sufficient threaded length, it is believed that the taper can be as low as 1/20. However, it is preferred by combining the features of FIG. 2 (steeper taper and shorter perfect thread length) and FIG. 3 (slower taper longer perfect thread length) to optimize the joint design and performance.

By practicing the invention, the goal of reducing the outside diameter of the box or male end of the coupling is achieved without a loss in joint performance by unduly minimizing the box end thickness. This is accomplished by controlling both the thickness of the box end and the pin end to satisfy the relation as outlined above for Sp and each of Sc and Sp1. In this way, the disadvantages of making Sc too thin when seeking to reduce the overall diameter of the joint are avoided. It is believed that the invention can be used for any type of pipe, including different materials, and different sizes and application. It is preferred that the pipe is a corrosion resistant pipe for oil drilling as discussed above.

As such, an invention has been disclosed in terms of preferred embodiments thereof which fulfills each and every one of the objects of the present invention as set forth above and provides a new and improved threaded pipe joint. Of course, various changes, modifications and alterations from the teachings of the present invention may be contemplated by those skilled in the art without departing from the intended spirit and scope thereof. It is intended that the present invention only be limited by the terms of the appended claims.

I claim:

1. In a threaded pipe joint having a main pipe with an externally threaded male end on each end thereof, and a coupling, at least one of the externally threaded male ends adapted to engage an internally threaded female end of the coupling, the main pipe having a wall thickness of Sp, the improvement comprising an externally threaded tapered male end having a wall thickness in cross section of Sp1 measured at a portion adjacent the main pipe defined, wherein Sp1=(0.55-0.79)×Sp, and an internally threaded tapered female end of the coupling having a wall thickness in cross section of Sc measured at an onset of a taper of the female end defined by Sc, wherein Sc=(0.55-0.79)×Sp.

2. The pipe of claim 1, wherein Sp1 is not less than Sc.

3. The pipe of claim 1, wherein the externally threaded male end has a taper that varies from 1/12 to 1/20.

4. The pipe of claim 1, wherein Sp1=(0.58-0.65)×Sp and Sc=(0.58-0.65)×Sp.

5. The pipe of claim 1, wherein Sp1=0.6 Sp and Sc=0.6 Sp.

6. In a method of joining an externally threaded male end of a pipe to an internally threaded female end of a coupling to form a pipe joint, the improvement comprising using the pipe and coupling of claim 1 .

7. In a method of joining an externally threaded male end of a pipe to an internally threaded female end of a coupling to form a pipe joint, the improvement comprising using the pipe and coupling of claim 2.

8. In a method of joining an externally threaded male end of a pipe to an internally threaded female end of a coupling to form a pipe joint, the improvement comprising using the pipe and coupling of claim 3.

9. In a method of joining an externally threaded male end of a pipe to an internally threaded female end of a coupling to form a pipe joint, the improvement comprising using the pipe and coupling of claim 4.

10. In a method of joining an externally threaded male end of a pipe to an internally threaded female end of a coupling to form a pipe joint, the improvement comprising using the pipe and coupling of claim 5.
